(19) United States
(12) Patent Application Publication
(10) Pub. No.: US 2004/0068738 A1
(43) Pub. Date: Apr. 8, 2004

(54) Event program distribution system and method

(75) Inventor: Haruhiko Kinoshita, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/671,632

(22) Filed: Sep. 29, 2003

(30) Foreign Application Priority Data
Sep. 27, 2002 (JP) 2002-282701

(51) Int. Cl. H04N 7/167

(52) U.S. Cl. 725/31; 725/97

(57) ABSTRACT

A request message is transmitted to a server (21) from program receiving sites (40) each having a video screen whose size is sufficient for viewing by public audience. The server replies with a blank application form containing a list of scheduled event programs and their scheduled date and time scales each indicating the program's opening and closing times of day. Each program receiving site fills in the application form and returns it to the server. In the server, event programs indicated in the received application form are mapped in a registration database to the requesting program receiving sites, and the database is constantly is monitored for each event program. From an event holding site (30) the server receives an event program when its scheduled opening time is detected and distributes it to the registered receiving sites until the scheduled closing time of the program is detected.

### BACKGROUND OF THE INVENTION

1. Field of the Invention

The present invention relates generally to video distribution systems, and more specifically to an event program distribution system for distributing a video program from an even-holding place such as concert halls to public users via a communications network such as IP network.

2. Description of the Related Art

As disclosed in Japanese Patent Publication 2001-204003, the program of a public event held in a concert hall is distributed through an IP network to users' personal computers and displayed on a small-sized screen. Because of the limited screen size, the user cannot feel and appreciate the real sense of presence in the place of live performance. On the other hand, large screen display systems have been developed and used in relatively small public gathering places such as game centers, movie theaters and “Karaoke” halls (where people gathers for singing favorite songs to the melody of recorded music played by an orchestra). If the event program is distributed to such relatively small public gathering places and displayed on large video screens, the users' impression to the event performance would be much greater than they have with their small-size screen. However, the interest of the event provider is not protected if the program receiving sites are free to access the center of an event program distribution system. Additionally, there are unprofitable times for the relatively small public gathering places described above, depending on days of the week and time of day. It is desirable to enable efficient utilization of the video systems provided in such public gathering places.

### SUMMARY OF THE INVENTION

It is therefore an object of the present invention to provide an event program distribution system and method for enabling distribution of an event program to a number of program receiving sites to be displayed on a video screen whose size is sufficient for viewing by public audience.

According to a first aspect of the present invention, there is provide an event program distribution system comprising an event gathering system connected to a network, a plurality of program receiving sites connected to the network for transmitting a request message to the network, each of the receiving sites having a screen whose size is sufficient to be viewed by public audience, and a server connected to the network for receiving the request message and transmitting a blank application form to the network, containing a list of scheduled event programs and their scheduled date and time scale indicating the opening and closing times of day. The program receiving sites are responsive to the blank application form for returning a filled-in application form to the network containing one or more requested event programs. The server responds to the filled-in application form by mapping each of a plurality of requested event programs indicated in the application form in a registration memory to one or more requesting program receiving sites. The server monitors the memory for detecting the date and time scales of each event program, and receives an event program from said event gathering system when the scheduled date and opening time of day of the program are detected and distributes the received event program to one or more program receiving sites which are mapped to the event program until the scheduled closing time of day of the program is detected.

According to a second aspect, the present invention provides a method of distributing an event program, comprising the steps of transmitting a request message from a plurality of program receiving sites to a server, each of the program receiving sites having a screen whose size is sufficient for viewing by public audience, receiving, at the server, the request message and transmitting a blank application form to the program receiving sites, containing a list of scheduled event programs and their scheduled date and time scale indicating the opening and closing times of day, transmitting a filled-in application form to the server, containing one or more requested event programs from the program receiving sites in response to the blank application form, responsive to the filled-in application form, mapping each of a plurality of event programs in a registration memory to one or more requesting program receiving sites, and monitoring the memory for detecting the date and opening time of day of each event program and receiving, at the server, an event program from an event gathering site when the date and opening time of day of the program are detected and distributing the received event program to one or more program receiving sites which are mapped to the event program until the closing time of day of the program is detected.

### BRIEF DESCRIPTION OF THE DRAWINGS

The present invention will be described in detail further with reference to the following drawings, in which:

FIG. 1 is a block diagram of an event program distribution system of the present invention;

FIG. 2 is an illustration of an application form transmitted between a program distribution server and a requesting receive site;

FIG. 3 is an illustration of a list of entries for different event programs requested by receiving sites and stored in a database of the server;

FIG. 4 is a flowchart of the operation of the server when an application form is transmitted from the server to a requesting receive site in response to a request message from the receive site; and

FIG. 5 is a flowchart of the operation of the server when an event program is distributed to requesting receive sites.

### DETAILED DESCRIPTION

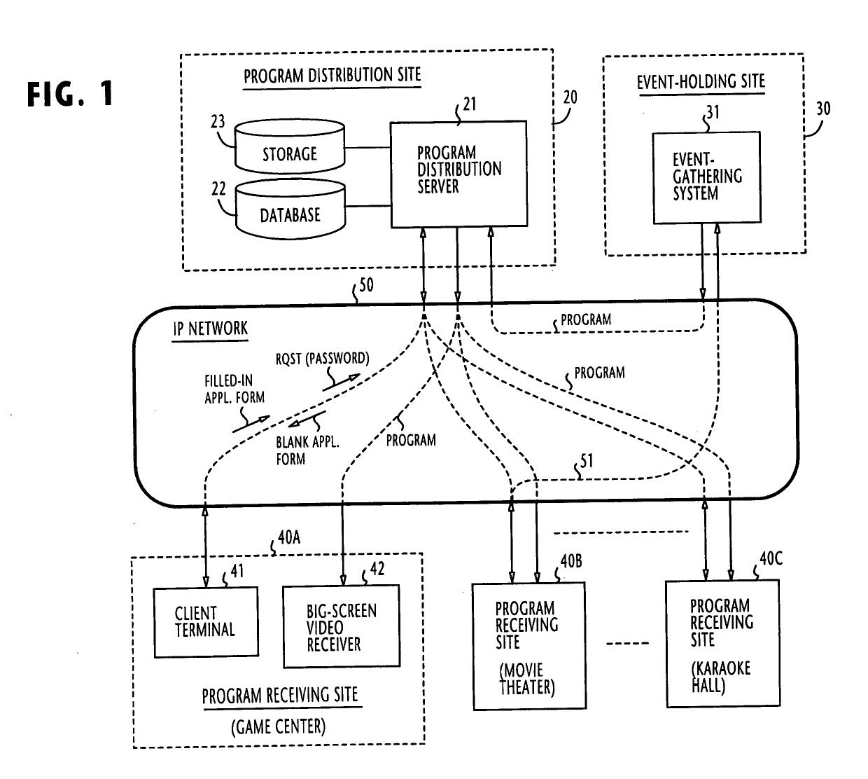

Referring to FIG. 1, there is shown a public event distribution system according to the present invention. The system includes an event program distribution site 20, an event-holding site (i.e., large public gathering place) 30 where a public performance is being held, and a plurality of program receiving sites (i.e., relatively small public gathering places) 40A, 40B and 40C such as game center, movie theater and Karaoke hall. An IP (internet protocol) network 50 is used to transmit a live event program from the event-holding site 30 to the event program distribution site 20.

Program distribution site 20 includes a program distribution server 21, a database 22 for storing registration data received from the program receiving sites 40 and a program storage device 23 for storing, if necessary, the live program transmitted from the even-holding site 30. The received live program may be distributed through the network 50 on a real-time mode or the live program is recorded in the storage device 23 and distributed on a time-shift mode. Program distribution server 21 is managed by a system manager. The server 21 has the functionality of a world-wide-web server to perform subscription and alteration of users and is responsible for the management of a web page on the Internet.

Event-holding site 30 is provided with an event-gathering system 31 including one or more video cameras and a sound system. The event-gathering system 31 is connected to the IP network 50 via an appropriate interface, not shown, to transmit a composite video signal to the program distribution server 21.

Each of the program receiving sites 40 is a subscribed user of the system and includes a client terminal 41 and a big-screen video receiver 42. In each program receiving site 40, or game center 40A for example, the client terminal 41 transmits a request message to the program distribution server 21 over the IP network by specifying its URL. The request message contains a password assigned to the subscribed receiving site. If the password is verified by the server 21, a blank application (registration) form is transmitted through the network 50 to the client terminal 41. The video receiver 42 is also connected to the IP network via an appropriate interface, not shown, to receive an event program transmitted from the distribution server 21.

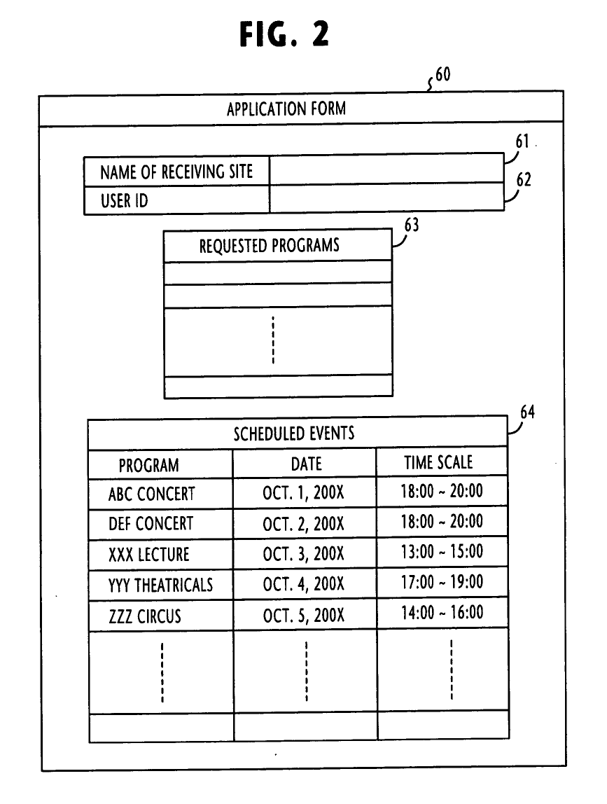

As shown in FIG. 2, the application form is displayed on the screen of the client terminal, or personal computer 41 as a window 60. The displayed application form includes blank entries 61, 62 and 63, which the requesting site is requested to insert the name of receiving site, the user ID and a list of requested programs, respectively. A list of scheduled events 64 is displayed to allow the requesting site to select one or more desired event programs and inserts the selected programs to the “requested programs” entry 63. Each entry of the scheduled events includes the name of an event program, the date on which the program is to be performed and the time of day indicating the opening and closing times of day of the program.

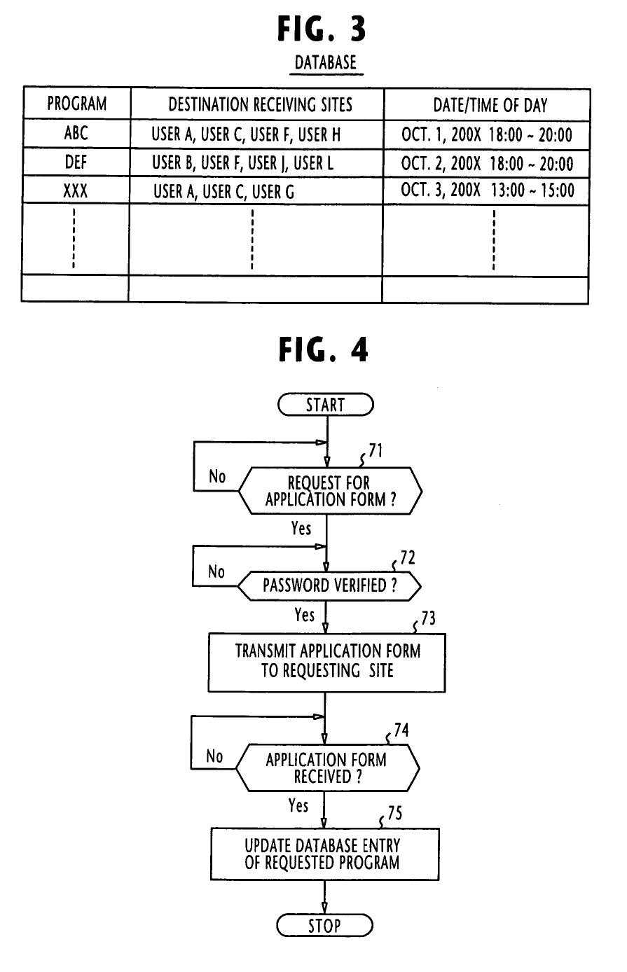

Once the application form is filled in, the requesting site 40 transmits the application form to the server 21. In response, the program distribution server 21 makes registration of the requesting site 40 by creating a new entry in the database 22 or updates an existing entry of the database 22 with new information (see FIG. 3).

During a program application mode of the system, the operation of the program distribution server 21 proceeds according to the flowchart of FIG. 4. When a request message for an application form is received from a subscribed program receiving site 40 (step 71), the server 21 verifies the password contained in the request message. If the password is verified (step 72), flow proceeds to step 73 to transmit the application form of FIG. 2 to the requesting site. After the receiving site fills in the application form and transmits it to the network 50, the server 21 receives it at step 74 and updates the database (step 75). As shown in FIG. 3, the database 22 includes a plurality of entries corresponding to a plurality of event programs identified by the names of event program transmitted from program receiving sites 40. In each entry, the name of the event program is mapped to one or more subscribed names of receiving sites which have requested the event program in their application forms and the timing data of the event program.

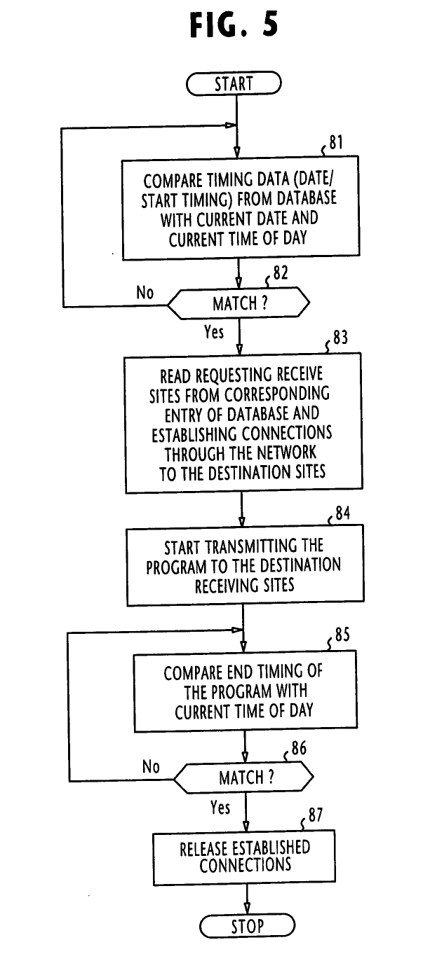

Program distribution server 21 distributes an event program to the program receiving sites 40 which have requested that program. During a program distribution mode of the system, the operation of program distribution server 21 proceeds according to the flowchart of FIG. 5.

At step 81, the distribution server 21 reads timing data (date and time of day) from each entry of the database 22 for a comparison between the stored date and the current date and a comparison between the stored opening time of day and the current time of day. If both of these data match in an entry of the database 22 (step 82), flow proceeds to step 83 to read the requesting receive sites 40 from the entry as destination sites and establishes connections through the IP network 50 to the destination sites. At step 84, the server 21 starts transmitting the requested event program to the destination receive sites over the established connections. Meanwhile, the server 21 reads and the closing time of day from the matched entry for comparison with the current time of day (step 85). If they match (step 86), the server 21 terminates the event program distribution by releasing the established connections (step 87).

The video signal is preferably compressed and/or encrypted at the distribution server 21 and decompressed and/or decrypted at each of the requesting sites. Further, the distribution server 21 may perform a format conversion on a distributed program so that the transmitted program complies with the format of the video receiver of a receiving site.

In each of the requesting receive sites 40 where peoples are gathering to enjoy a public event, the video receiver 42 receives the transmitted composite video signal of the event program and displays the video signal on its big-screen screen and drives a number of loudspeakers with the sound signal of the composite video signal. If a live program is used for distribution, the sense of reality of the live performance can be gained. In this way, the existing video systems of relatively small public gathering sites can be fully utilized to gain profit from the distributed programs when these systems remain idle for their normal purposes. This also adds to full utilization of the event program, and represents a new style of commercial activity.

If the program receiving site is a game center, it would be best to request those event programs which can be displayed during the times the game center's big-screen facility is not used for its normal commercial service. In a similar manner, a movie theater may request those event programs which can be used on its video projection and sound system during weekdays and times of day when customers are very few to gain sufficient profit. The same applies to “Karaoke” halls.

Utilization efficiency of existing video display systems of the relatively small public gathering sites can be improved in this way. Another beneficial effect of the present invention is that there is a possibility for the relatively small public gathering sites to attract new customers of different generations and different sex than the customers who frequently visit the sites for normal commercial services. In a “Karaoke” hall, for example, if a live lecture of a TV personality is displayed on its large screen during the daylight time of weekdays when normal customers are extremely few to visit, its unused facility will be utilized to attract a group of housewives.

In a preferred embodiment, the client terminal 41 of a movie theater 40B, for example, is provided with a microphone (not shown) and a VoIP protocol to establish a speech path 51 through the network 50 to the event-holding site 30. If the video program of a lecture of a designated person is distributed to the movie theater 40B, a two-way speech communication can be performed between the lecturer and the audience of the receiving site. This allows the audience to submit questions to the lecturer and receive his reply on a real-time basis.

In a preferred embodiment, the distribution server 21 may announce scheduled event programs and their contents on its home page. The home page of the server 21 may further includes destination receive sites where the schedule event programs are displayed.

In a further preferred embodiment of the present invention, a requesting receive site 40 transmits a request message to the server 21, containing a time interval during which normal commercial activity is low. In response, the distribution server 21 sends a return message containing a list of event programs that can be distributed during the specified time interval. On receiving the return message, the requesting site selects one or more desired programs from those listed in the received message.

Event program distribution server 21 may send a billing message to the requesting sites on an event-by-event basis for requesting them to transfer a charged amount to a bank's account specified by the server 21.

What is claimed is:

1. An event program distribution system comprising:
an event gathering system connected to a network;
a plurality of program receiving sites connected to the network for transmitting a request message to the network, each of said receiving sites having a screen whose size is sufficient to be viewed by public audience;
a server connected to the network for responding to said request message with a blank application form said receiving sites via the network, said application form containing at least one scheduled event program and a scheduled date and a time scale of the program, the time scale indicating opening and closing times of day of the event program;
said program receiving sites being responsive to said blank application form for returning a filled-in application form to the server via the network, said application form indicating one or more requested event programs,
said server being responsive to said filled-in application form for mapping each of a plurality of requested event programs indicated in the application form in a memory to one or more requesting program receiving sites, monitoring the memory for detecting the date and time scales of each event program, receiving an event program from said event gathering system when the scheduled date and opening time of day of the program are detected and distributing the received event program to one or more program receiving sites which are mapped to the event program until the scheduled closing time of day of the program is detected.

2. The event program distribution system of claim 1, wherein said event program is distributed on a real-time basis.

3. The event program distribution system of claim 1, wherein said program receiving sites include a game center.

4. The event program distribution system of claim 1, wherein said program receiving sites include a movie theater.

5. The event program distribution system of claim 1, wherein said program receiving sites include a “Karaoke” hall.

6. The event program distribution system of claim 1, wherein said program receiving sites establish a two-way speech path to said event gathering system.

7. A method of distributing an event program, comprising the steps of:
transmitting a request message from a plurality of program receiving sites to a server, each of said program receiving sites having a screen whose size is sufficient to be viewed by public audience;
receiving, at said server, said request message and transmitting a blank application form to the program receiving sites, containing at least one scheduled event program, a scheduled date and a time scale for the event program, the time scale indicating opening and closing times of day of the program;
transmitting a filled-in application form to the server, containing one or more requested event programs from said program receiving sites in response to said blank application form;
responsive to said filled-in application form, mapping each of a plurality of event programs in a memory to one or more requesting program receiving sites; and
monitoring said memory, at said server, for detecting the date and the time scale of each event program mapped in said memory and receiving an event program from an event gathering system when the date and the opening time of day of the event program are detected and distributing the received event program from said server to one or more program receiving sites which are mapped in said memory to the event program until the closing time of day of the event program is detected.

8. The event program distribution system of claim 1, wherein said event program is distributed on a real-time basis.

9. The event program distribution system of claim 1, further comprising the step of establishing a two-way speech communication path between to said program receiving sites and said server.

10. A computer readable storage medium embodying a program for executing the steps of claim 7, 8 or 9.
